(19) United States
(12) Patent Application Publication
(10) Pub. No.: US 2019/0373348 A1
(43) Pub. Date: Dec. 5, 2019

(54) Speaker Box

(71) Applicant: AAC Technologies Pte. Ltd., Singapore city (SG)

(72) Inventor: Yanlong Wang, Shenzhen (CN)

(21) Appl. No.: 16/427,124

(22) Filed: May 30, 2019

(30) Foreign Application Priority Data
Jun. 1, 2018 (CN) 201820852804.8

(51) Int. Cl. H04R 1/02; H04R 9/06; H04R 9/02; H04R 1/28

(52) U.S. Cl. CPC H04R 1/025; H04R 9/06; H04R 2499/11; H04R 1/2888; H04R 9/025

(57) ABSTRACT

The present disclosure discloses a speaker box with an air permeable member with air permeable layer and the sealing layer. The air permeable layer is coupled to the sealing layer by the first layer, and the air permeable layer is coupled to the housing by the second layer. The air permeable layer includes notches corresponding to the first and second layers, by which the first layer is coupled with the second layer. The combination between the air permeable member and the housing is enhanced. And, the combination between internal components forming the air permeable member is also enhanced.

### FIELD OF THE PRESENT DISCLOSURE

The present disclosure relates to the field of electro-magnetic transducers, more particularly to a speaker box used in a portable electronic device.

### DESCRIPTION OF RELATED ART

A speaker is a very important component equipped in a mobile phone for producing audible sounds. A speaker generally uses a diaphragm to produce vibration and further to generate sounds.

A speaker box is a component containing a speaker and a housing receiving the speaker. Compared to a speaker, a speaker box has a relatively larger back volume and better low frequency acoustic performance. The speaker box has a sound aperture for radiating sound. For avoiding dust, the sound aperture should be covered by air permeable film. The air permeable film includes a hydrophobic/oleophobic sealing layer and adhesive layer. However, the hydrophobicity/oleophobicity of the sealing layer will badly affect the interface energy of the sealing layer, which will affect the combination of the sealing layer and the adhesive layer.

Therefore, an improved speaker box is desired.

### SUMMARY OF THE PRESENT DISCLOSURE

One of the primary objects of the present disclosure is to provide a speaker box with an improved air permeable film.

Therefore, the present disclosure provides a speaker box including: a housing with an accommodation space; a speaker received in the accommodation space for dividing the accommodation space into a front cavity and a back cavity; a sound aperture formed in the housing for communicating with the front cavity; an air permeable member covering the sound aperture, the air permeable member including an air permeable layer and a sealing layer coupled to a side of the air permeable layer far away from the sound aperture; a first layer coupling the air permeable layer and the sealing layer; a second layer coupling the air permeable layer and the housing. The air permeable layer includes a plurality of notches corresponding to the first and second layers thereby coupling the first layer with the second layer.

Further, the housing includes a bottom wall, an upper case opposite to the bottom wall, and a sidewall perpendicularly extending from the bottom wall, the sound aperture is disposed in the sidewall, and the air permeable member is fixed on the sidewall.

Further, the first and second layers are ring-shaped structure surrounding the sound aperture.

Further, the first and second layers are double-side adhesive tape.

Further, the notches are semicircular and arranged in an edge of the air permeable.

Further, the notches are semicircular and evenly arranged in an edge of the air permeable.

Further, the air permeable layer is a mesh with hydrophobicity/oleophobicity for performing dust-proof and water-proof function.

Further, the sealing layer is a sealing foam.

Further, the bottom wall includes a fastening portion extending toward the upper case for positioning the speaker.

Further, the sidewall includes a sound radiation part extending away from the accommodation space, the sound radiation part includes the sound aperture; and the air permeable member is coupled with the sound radiation part.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an illustrative isometric view of a speaker box in accordance with an exemplary embodiment of the present disclosure.

FIG. 2 is an isometric and exploded view of the speaker in FIG. 1.

FIG. 3 is a cross-sectional view of the speaker box, taken along line A-A in FIG. 3.

FIG. 4 is an enlarged view of Part B in FIG. 3.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

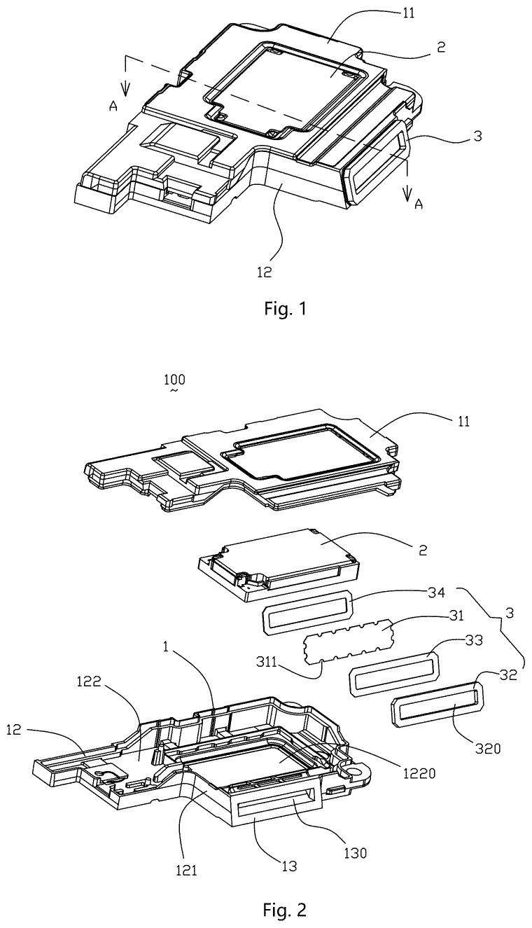

Referring to FIGS. 1-3, a speaker box 100 in accordance with an exemplary embodiment of the present disclosure includes a housing 1 with an accommodation space and a speaker 2 received in the housing 1.

The housing 1 includes a lower case 12, an upper case 11 forming the accommodation space with the lower case 12. The lower case 12 further includes a sidewall 121 and a bottom wall 122. The sidewall 121 extends perpendicularly from the bottom wall 122. The bottom wall 122 includes a fastening portion 1220 for fixing the speaker 2. In the embodiment, the fastening portion 1220 is arranged at a center of the bottom wall 122, which makes the speaker 2 keep a distance from the sidewall 121.

The speaker 2 is an electro-magnetic transducer. The speaker 2 includes a diaphragm and a coil for driving the diaphragm to vibrate. One side of the diaphragm is fixed inside the fastening portion 1220. The speaker 2 and the lower case 12 forms a front cavity. The diaphragm of the speaker and the bottom wall 122 forms a back cavity. The back cavity of the speaker box communicates with a back acoustic volume of the speaker for enlarging the back cavity of the speaker box to improve the low frequency acoustic performance. Further, the sidewall 121 of the lower case 12 includes a sound radiation part 13 extending away from the accommodation space. The sound radiation part 13 includes a sound aperture 130 communicating with the front cavity 101.

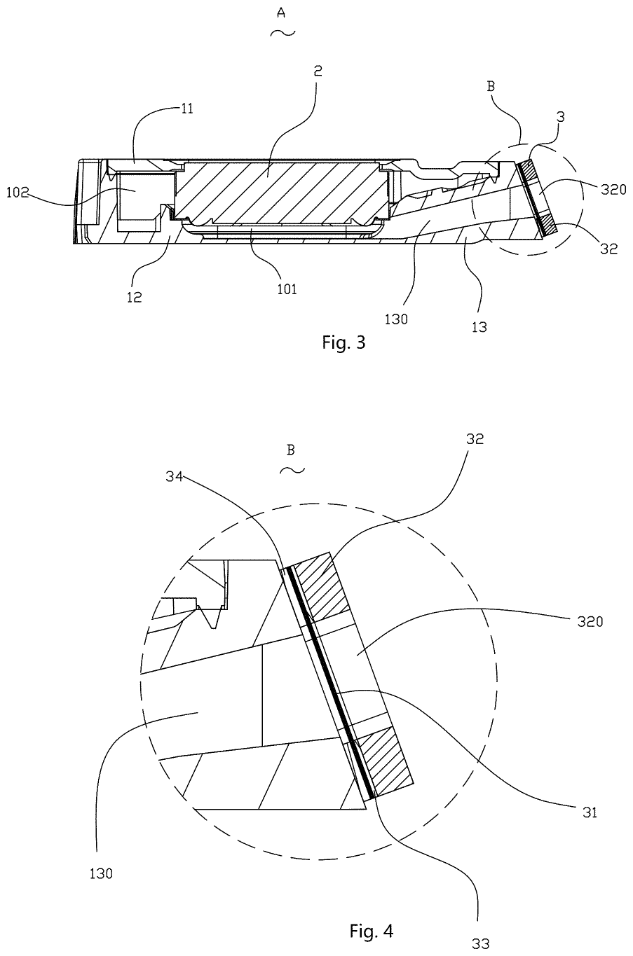

Referring to FIGS. 3-4, the speaker box further includes an air permeable member 3 covering the sound aperture 130 of the sound radiation part 13. The air permeable member 3 includes an air permeable layer 31, a sealing layer 32 and an adhesive layer. The air permeable layer 31 is a mesh with hydrophobicity/oleophobicity for performing dust-proof and water-proof function. The air permeable layer 31 completely covers the sound aperture 130. The sealing layer 32 is a sealing foam and is disposed on a side of the air permeable member 3 far away from the sound aperture 130. The sealing layer 32 forms a through hole 320 communicating with the sound aperture 130.

The adhesive layer includes a first layer 33 located between the air permeable layer 31 and the sealing layer 32, and a second layer 34 disposed between the air permeable layer 31 and the sidewall 121. The first layer 33 is used for coupling the air permeable layer 31 with the sealing layer 32, and the second layer 34 is used for coupling the air permeable member 3 with the housing 1. The first and second layers are ring-shaped double-side adhesive tape surrounding the sound aperture. The air permeable layer 31 includes a plurality of notches 311 corresponding to the first and second layers 33, 34, by which the first layer 33 is coupled with the second layer 34. Optionally, the notches 311 are semicircular and arranged evenly in an edge of the air permeable layer 31.

The speaker box provided by the present disclosure has an improved stability, by virtue of the air permeable member with air permeable layer and the sealing layer. The air permeable layer is coupled to the sealing layer by the first layer, and the air permeable layer is coupled to the housing by the second layer. The air permeable layer includes a plurality of notches corresponding to the first and second layers, by which the first layer is coupled with the second layer. The combination between the air permeable member and the housing is enhanced. And, the combination between internal components forming the air permeable member is also enhanced.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker box, including:
a housing with an accommodation space;
a speaker received in the accommodation space for dividing the accommodation space into a front cavity and a back cavity;
a sound aperture formed in the housing for communicating with the front cavity;
an air permeable member covering the sound aperture, the air permeable member including an air permeable layer and a sealing layer coupled to a side of the air permeable layer far away from the sound aperture;
a first layer coupling the air permeable layer and the sealing layer;
a second layer coupling the air permeable layer and the housing; wherein
the air permeable layer includes a plurality of notches corresponding to the first and second layers thereby coupling the first layer with the second layer.

2. The speaker box as described in claim 1, wherein the housing includes a bottom wall, an upper case opposite to the bottom wall, and a sidewall perpendicularly extending from the bottom wall, the sound aperture is disposed in the sidewall, and the air permeable member is fixed on the sidewall.

3. The speaker box as described in claim 1, wherein the first and second layers are ring-shaped structure surrounding the sound aperture.

4. The speaker box as described in claim 3, wherein the first and second layers are double-side adhesive tape.

5. The speaker box as described in claim 3, wherein the notches are semicircular and arranged in an edge of the air permeable.

6. The speaker box as described in claim 3, wherein the notches are semicircular and evenly arranged in an edge of the air permeable.

7. The speaker box as described in claim 1, wherein the air permeable layer is a mesh with hydrophobicity/oleophobicity for performing dust-proof and water-proof function.

8. The speaker box as described in claim 1, wherein the sealing layer is a sealing foam.

9. The speaker box as described in claim 2, wherein the bottom wall includes a fastening portion extending toward the upper case for positioning the speaker.

10. The speaker box as described in claim 2, wherein the sidewall includes a sound radiation part extending away from the accommodation space, the sound radiation part includes the sound aperture; and the air permeable member is coupled with the sound radiation part.
